(19) United States
(12) Patent Application Publication
(10) Pub. No.: US 2016/0254737 A1
(43) Pub. Date: Sep. 1, 2016

(54) Electromagnetic Angular Acceleration Propulsion System

(71) Applicant: James W. Purvis, Albuquerque, NM (US)

(72) Inventor: James W. Purvis, Albuquerque, NM (US)

(21) Appl. No.: 14/632,604

(22) Filed: Feb. 26, 2015

(51) Int. Cl. H02K 47/00

(52) U.S. Cl. CPC H02K 47/00; H02K 2207/00

(57) ABSTRACT

The present invention discloses systems and methods for electromagnetic propulsion. The electromagnetic propulsion or thrusting systems include two or more electromagnetic coils, a means for rotating one of the electromagnetic coils, and a means for periodically shaping the intensity. duration and polarity of magnetic fields from the coils. In particular, these systems and methods use the interaction between the angular acceleration components of the electromagnetic field generated by the rotating coil with the geometry of one or more stationary electromagnetic coils to achieve thrust without expelling mass.

### FIELD OF THE INVENTION

This invention relates generally to the field of spacecraft propulsion. More specifically, the invention relates to spacecraft propulsion systems and methods which provide thrust without expelling propellant. In particular, the systems and methods of the present invention use the interaction between the angular acceleration components of the electromagnetic field generated by a rotating coil with the geometry of one or more other electromagnetic coils to achieve thrust without expelling mass.

### BACKGROUND OF THE INVENTION

A major issue facing future space exploration is advanced propulsion technologies. The combination of reaction mass and engine mass in traditional propulsion systems imposes practical limits to space missions. NASA and industry have addressed this problem by identifying and developing new propulsion concepts requiring either minimal or no propellant mass. The result has been the development of electric ion thrusters with high specific impulse, and field effect propulsion systems, or propellantless propulsion, requiring no reaction mass.

Specific impulse, which is the ratio of thrust produced to the rate of propellant consumed, is one of the most significant metrics for a space propulsion system. Specific impulse has units of seconds, and is essentially the number of seconds that a pound of propellant will produce a pound of thrust. A higher the specific impulse requires a lower propellant mass for a given space mission. Current space propulsion systems have a specific impulse range from 300 seconds to 10,000 seconds, with thrust level being generally inversely proportional to specific impulse. By way of example for comparison, the LOX-H2 space shuttle main engines have a specific impulse of about 450 s, nuclear thermal rockets about 900 s, and electric ion and magnetic plasma engines range from 5000 s-9000 s.

Table 1 compares several current high specific impulse space propulsion systems, including vacuum arc, hall effect, and magnetoplasma engines. One type of Hall effect thruster is described, for example, in U.S. Pat. No. 8,468,794 issued to Patterson, which is the basis for the HiVHAC device. U.S. Pat. No. 7,053,333 issued to Schein et al. describes the AASC vacuum arc thruster, while U.S. Pat. No. 6,334,302 issued to Chang-Diaz describes the VASIMR magnetoplasma ion thruster. Such systems are very fuel efficient; however, they require large amounts of power, typically 1 kWe per 0.030-0.040 Newtons of thrust for ion thrusters, and 1 kWe per 0.050-0.080 Newtons of thrust for Hall-effect thrusters.

TABLE 1

| | Thrust | Power | Isp | | |
|---|---|---|---|---|---|
| Device | (mN) | (kW) | (sec) | propellant | type |
| AASC- | 0.125 | 0.010 | 1500 | Metal ion | Vacuum arc |
| VAT | | | | | |
| NASA | 0.86 | 0.07 | 1370 | Teflon | Pulsed plasma |
| PPT | | | | | |
| NSTAR | 92 | 2.3 | 3300 | Xe | Electrostatic |
| HiVHAC | 150 | 3.6 | 2800 | Xe | Hall effect |
| VASIMIR VX- | 5000 | 200 | 5000 | Ar | magnetoplasma |
| 200 | | | | | |

### PRIOR ART FOR PROPELLANTLESS ELECTROMAGNETIC PROPULSION

Field propulsion, or propellantless propulsion, which employs electromagnetic field effects for generating propulsion forces, expels no reaction mass, and therefore effectively has an infinite specific impulse. Recent experimental investigations validated by NASA have demonstrated apparent validity of field propulsion.

Table 2 presents a comparison of experimental results for several propellantless propulsion devices. As disclosed in U.S. Pat. Nos. 2,949,550 and 3,187,206 to T. T. Brown, through an electrokinetic phenomenon termed the Biefeld-Brown Effect, electrical energy input into asymmetrical capacitors can be converted to mechanical energy which then provides a force for propelling an object. NASA is still investigating the use of Brown's discovery, as disclosed in U.S. Pat. No. 6,317,310 to Campbell. Another such device is disclosed in U.S. Pat. No. 6,492,784 to Serrano, which generates the Biefeld-Brown Effect using stacked-disc asymmetrical capacitors. Debate is ongoing in the literature as to whether the Biefeld-Brown Effect will work in the vacuum of space. Another limitation to using the effect may be the scalability potential, since asymmetrical capacitor devices to date have only generated tens of milli-newtons of thrust from tens of watts of input power.

TABLE 2

| | | | Isp | |
|---|---|---|---|---|
| Device | Thrust (mN) | Power (kW) | (sec) | propellant |
| Biefeld-Brown Effect | 0.05 | 0.035 | Infinite | none |
| Fetta-Cannae Drive | 0.01 | 0.0105 | Infinite | none |
| NASA-EM test | 0.09 | 0.017 | Infinite | none |
| China-EM | 720 | 2.5 | Infinite | none |

Other propellantless propulsion concepts are under development. Electrodynamic structures, as disclosed in U.S. Pat. No. 7,913,954 to Levin, include a power system, a plurality of collectors, a plurality of emitters, and conductive paths for moving payloads through the Earth's magnetic field. An inertial propulsion device, as disclosed in U.S. Pat. No. 8,066,226 to Fiala, utilizes several interconnected gyroscopic elements and Earth's gravity field to move without propellant. The superconducting electromagnetic turbine, as disclosed in U.S. Pat. No. 8,575,790 to Ogilvie, uses a pair of counter-rotating electrodynamic superconductor rotors to displace the surrounding geomagnetic field. These devices do not have general space-based utility since they are restricted to operations within either the gravity field or the magnetic field of Earth.

The most current example of a propellantless field propulsion system is an electromagnetic drive system as disclosed in U.S. Pat. Appl. No. 20140013724 to Fetta, based on prior work in the UK and experiments in China. This system includes an axially-asymmetric resonant cavity with a conductive inner surface adapted to support a standing electromagnetic (EM) wave. The resonating cavity lacks second-axis axial symmetry, thereby causing the standing EM wave to induce a net unidirectional force on the resonant cavity, thus generating thrust without reaction mass. Experimental versions of these EM devices have reportedly produced thrust levels of micro-newtons up to milli-newtons from several kilowatts of input power, as noted in Table 2.

### SUMMARY OF THE INVENTION

It is the objective of the current disclosure to present systems and methods for exploiting an overlooked term in the vector potential solution to Maxwell's Equations for the magnetic field generated by moving charges. This term appears in the electromagnetic field equation solution for moving charged particles as the charged particle acceleration, and is generally called the displacement current. The basic principle of the current invention is to rotate a current-carrying coil such that the magnetic field component produced by the angular acceleration of the voltage-driven charges has a term that is proportional to the product of the voltage drift velocity and the angular rotation rate, in addition to the usual term with the square of the drift velocity. Other current-carrying coils are then subjected to this magnetic field component in such a geometric manner so as to produce thrust without expelling propellant.

Embodiments of the present invention generate thrust without the use of reaction mass or propellant, and do so in a manner distinct from the devices and methods of Brown, Campbell, Serrano, Fetta, and others as mentioned above. Engineering calculations indicate that the present invention is scalable for general space-based applications. This invention is a significant improvement in options for producing both variable force and moment components as compared to other such propulsion devices. In addition to space-based applications, embodiments of the present invention may also be used to generate thrust in terrestrial applications. No evidence has been found in the literature of any device designed to take advantage of the electromagnetic effect as herein described for the present invention.

An exemplary embodiment of the present invention is an electromagnetic thruster, including: two or more electromagnetic coils, a means to rotate one of the coils at high angular rates, and a means to generate magnetic fields with varying polarity, intensity and duration from the coils. Engineering baseline calculations indicate that such an embodiment can generate thrust on the order of tens to hundreds of millinewtons. This invention is thus superior to existing high specific impulse electric thrusters, since the same thrust level can be produced without expelling propellant. Moreover, this invention is capable of a full throttle range simply by controlling either the angular rotation rate of the moving coils or varying the current through the reaction coils.

### BRIEF DESCRIPTION OF THE DRAWINGS

The accompanying drawings, which are incorporated in and form part of the specification, illustrate various principles of operation and examples of the present invention, including a preferred embodiment of the invention, as well as alternate embodiments, and, together with the detailed description, serve to explain the principles of the invention,

FIG. 1 is a schematic diagram illustrating the magnetic field generated by the angular acceleration of a charged particle moving on a curved path;

FIG. 2 is a schematic diagram illustrating the Lorentz force on a conducting segment generated by the angular acceleration of charged particles moving through a segment of a rotating current loop;

FIG. 3 is a schematic diagram illustrating the Lorentz component force at a point on a conducting loop generated by the angular acceleration of charged particles moving through a rotating current loop;

FIGS. 4A-B are schematic diagrams illustrating a top view and a section view of one embodiment of the present invention designed to produce a radial thrust;

FIGS. 5A-5B are two section view diagrams illustrating alternate embodiments of the present invention.

FIGS. 6A-B are schematic diagrams illustrating a cutaway view and a cross-section view of the preferred embodiment of the present invention designed to produce both axial and radial thrust.

### SCIENTIFIC BASIS FOR THE INVENTION

It is well known to those skilled in the art of classical mechanics that an object orbiting on a circular path will experience a radial acceleration proportional to the product of the angular rotation rate and the velocity of the object. The solutions of Maxwell's Equations for a current of charged particles, which are additionally undergoing a forced rotational motion of the conductor carrying the current, are found to contain a radial displacement current term which is proportional to the product of the voltage drift velocity and the rotational rate. Application of this magnetic field component, through appropriate geometric design, to one or more static electromagnetic coils produces unbalanced Lorentz force components on the complete system, thereby producing thrust without expelling propellant.

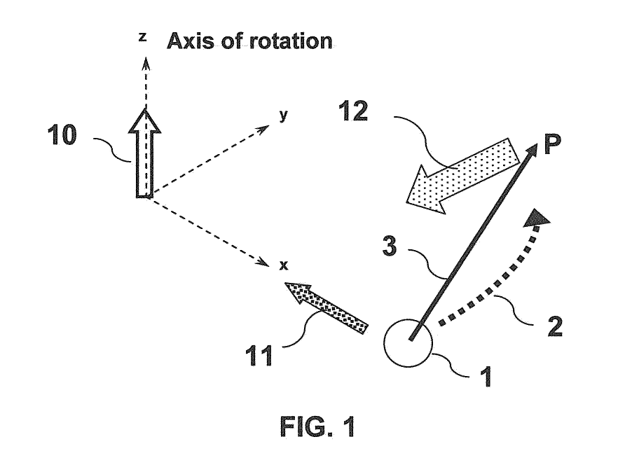

By way of background, and with reference to FIG. 1, it is well known to those skilled in the art that a charged particle 1 moving with velocity 2 along a curved path in the x-y plane, as shown and centered on the z-axis, will experience an angular acceleration vector 11 pointing toward the instantaneous axis of rotation and equal in magnitude to the square of the velocity of the particle divided by the radius of curvature. If the path is an exact circle, the particle will appear to move under the influence of an angular rotation vector 10, which is the particle velocity divided by the radius of rotation. Further derivation from the vector potential solution of Maxwell's Equations for a moving charged particle shows that this angular acceleration of the charged particle will produce a magnetic field component 12 at any point P located at position 3 with respect, to particle 1. The necessary equations to calculate the magnitude and direction of this force 12 may be found in the current physics literature.

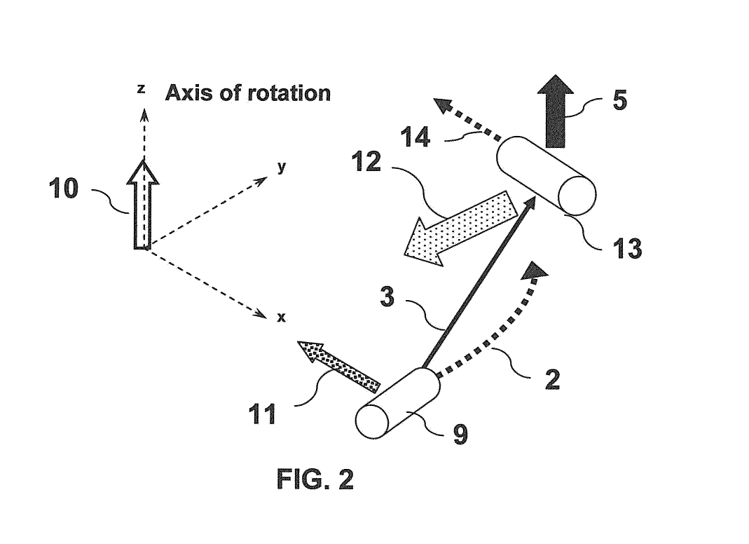

By way of further background with reference to FIG. 2, the single particle physics of FIG. 1 is expanded to apply to two discrete segments of current-carrying conductors, elements 9 and 13. Element 9 is a conductor segment lying in the x-y plane as shown and carrying an internal current of velocity 2. Element 13 is a static conductor segment carrying an internal current of velocity 14, is parallel to the x-axis, and is displaced from the x-y plane and from element 9 by position vector 3. Element 9 is further rotated about the z-axis with angular velocity 10. Thus the net velocity of each electron moving through element 9 is the sum of the voltage drift velocity and the velocity induced by the angular rotation. The net velocity of each proton fixed in element 9 is due solely to the angular rotation. Each electron in the current further experiences an angular acceleration 11 which has magnitude equal to the angular rate 10 multiplied by the total electron velocity. Each proton in the element 9 also experiences an angular acceleration 11 which has magnitude equal to the angular rate 10 multiplied by the proton rotational velocity. All moving charged particles in element 9 produce magnetic field components 12 at element 13, as well as Lorentz force components 5 due to the interaction of the current 14 with these magnetic fields. However, it may be proven from the appropriate electrodynamics equations that an unbalanced, or net, magnetic force component on this two-element system is produced by a component of the electron angular acceleration 11, namely the product of the rotation rate 10 and the voltage drift velocity of the electrons.

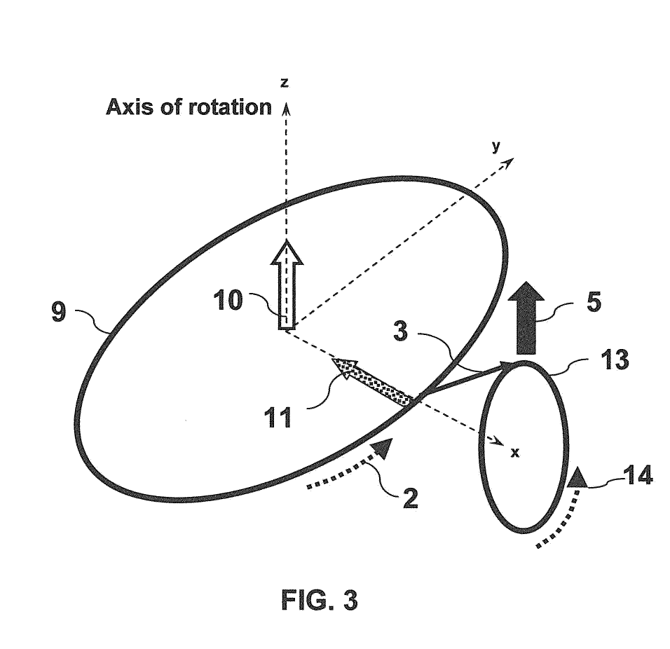

By way of further background with reference to FIG. 3, the conductor segments of FIG. 2 are expanded to apply to two complete current-carrying conductors, elements 9 and 13. Element 9 is a conductor loop lying in the x-y plane as shown and carrying an internal current of velocity 2. Element 13 is a static conductor loop carrying an internal current of velocity 14, lying in the x-z plane, displaced from element 9. Element 9 is further rotated about the z-axis with angular velocity 10. It is the purpose of the present invention to exploit the situation of FIG. 3 and produce a net system force, parallel to the axis of rotation, on continuous conductor coils comprised of elements 9 and 13.

### DETAILED DESCRIPTION OF PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

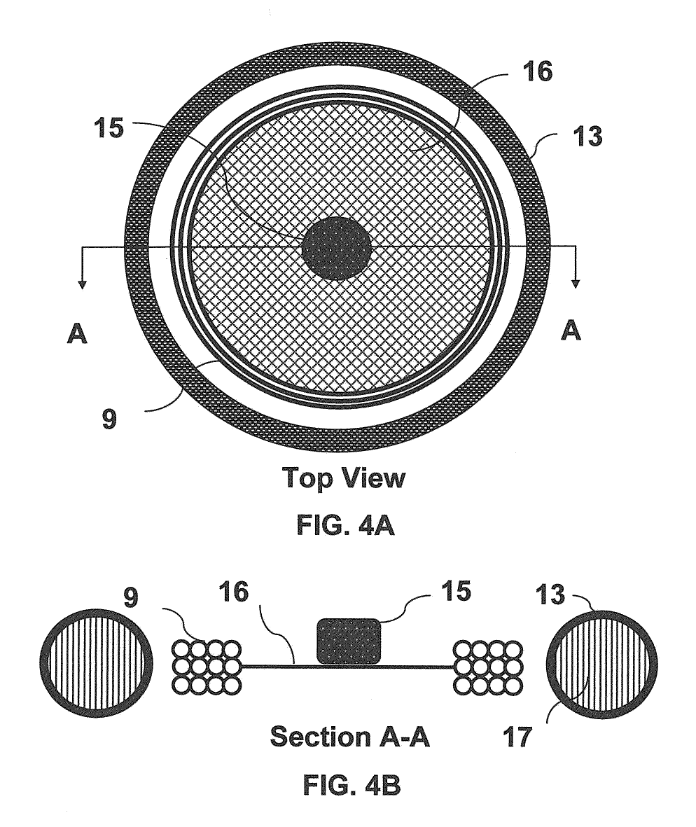

With reference to FIG. 4, a preferred embodiment of the present invention includes a plurality of conducting coils 9 arranged about an axis of symmetry on a circular disc 16. The disc assembly 9,16 is spun with angular velocity about its axis of symmetry by a means 15. A static torus of conducting coils 13 with a core 17 of high magnetic permeability surrounds and is coplanar with the disc assembly 9,16. At the appropriate design rotation speed, current is supplied to both sets of conductive coils 9 and 13, resulting in a net unbalanced Lorentz force on the torus 13 parallel to the angular velocity vector. The total system force may be shown to be proportional to the product of the current amplitudes, the total number of turns in coils 9 and 13, the angular velocity of coils 9, the relative magnetic permeability of core 17, and the usual physics factors for computing magnetic field intensity.

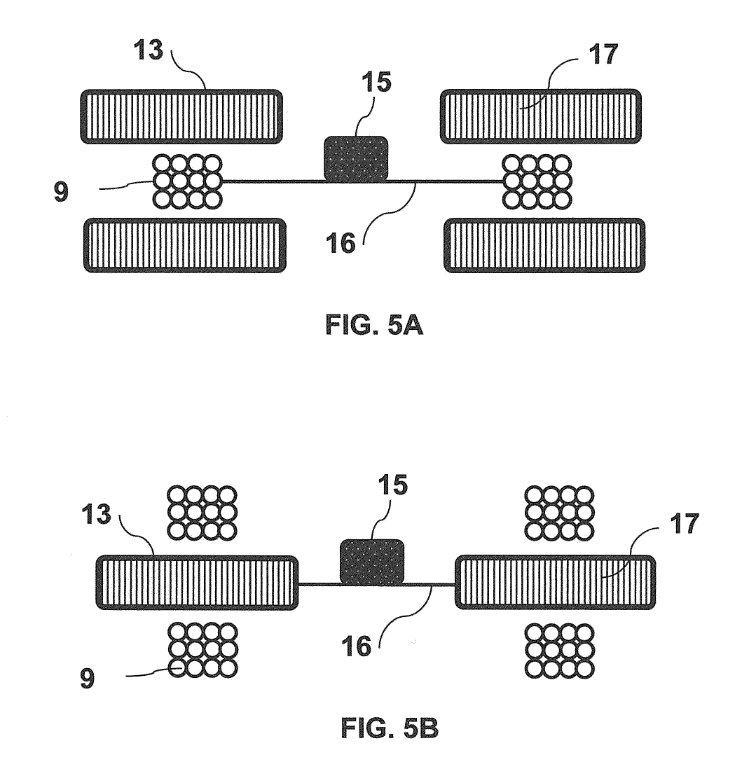

With reference to FIG. 5A, another embodiment of the present invention is shown in cross-section similar to FIG. 4B. In this embodiment, two coil and core assemblies 13,17, are each comprised of rectangular cross-section toroids, and are positioned in parallel planes above and below the rotating coils 9. As with the embodiment of FIG. 4, the total system force may be shown to be proportional to the product of the current amplitudes, the total number of turns in all coils 9 and 13, the angular velocity of coils 9, the relative magnetic permeability of core 17, and the usual physics factors for computing magnetic field intensity.

With reference to FIG. 5B, another embodiment of the present invention is shown in cross-section similar to FIG. 4B. In this embodiment, two coil assemblies 9 are each positioned in parallel planes above and below the rectangular rotating coils 13 with cores 17. As with the embodiment of FIG. 4, the total system force may be shown to be proportional to the product of the current amplitudes, the total number of turns in all coils 9 and 13, the angular velocity of coils 13, the relative magnetic permeability of core 17, and the usual physics factors for computing magnetic field intensity.

With further reference to FIGS. 4 and 5, simple design modifications to these embodiments may be used to produce enhanced force and torque production. By alternately stacking assemblies of coils 9 and coils 13 from the FIG. 5 embodiment, with all coils 9 rotated from a single means 15, the total uniaxial force will be increased in proportion to the number of rotating layers in the stack. For the embodiment of FIG. 4, by segmenting the coils 13, and applying different currents in each segment, planar translation forces as well as torques may be produced by the system.

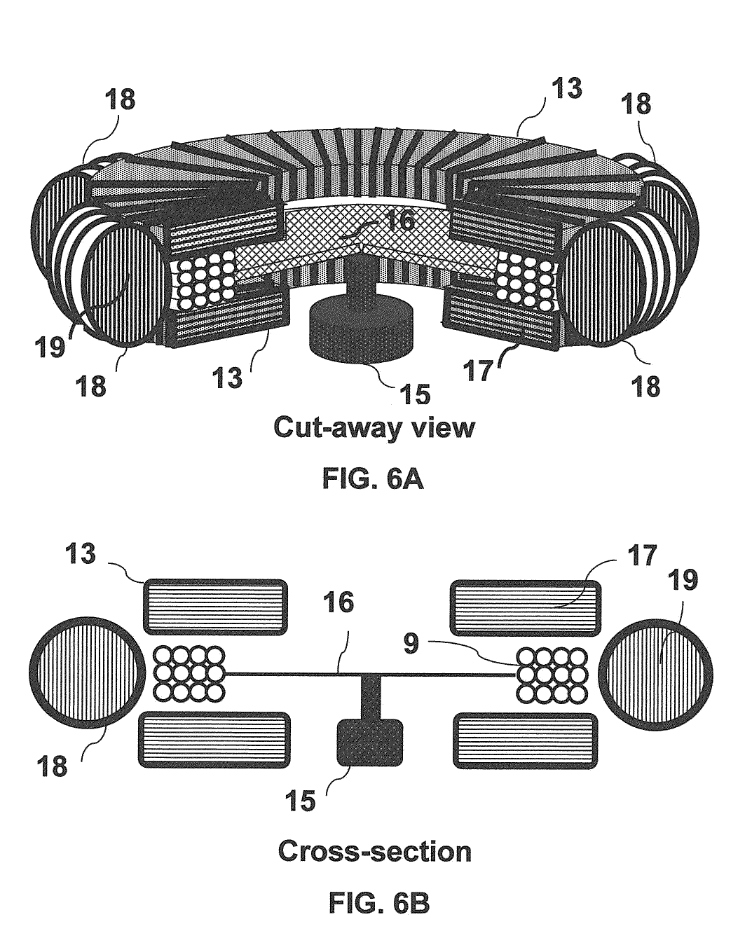

With reference to FIGS. 6A and 6B, the preferred embodiment of the present invention is shown both in cutaway and in cross-section similar to FIG. 4B. In this preferred embodiment, two rectangular toroidal coil and core assemblies 13,17 are positioned in parallel planes above and below the rotating coils 9, and an additional segmented circular toroidal coil and core assembly 18,19 is positioned circumferentially around the rotating coil 9. As with the previous embodiments, the total system forces and moments may be shown to be proportional to the product of the current amplitudes, the total number of turns in all coils 9, 13 and 18 the angular velocity of coil 9, the relative magnetic permeability of cores 17 and 19, and the usual physics factors for computing magnetic field intensity.

Table 3 compares predicted performance of the present invention with three current high specific impulse engines and one propellantless propulsion patent. Engineering design estimates indicate that the present invention is capable of producing the thrust levels of current propulsion systems with lower power consumption and no reaction mass.

TABLE 3

| Device | Thrust (mN) | Power (kW) | Isp (sec) | propellant |
|---|---|---|---|---|
| AASC-VAT | 0.125 | 0.010 | 1500 | Metal ion |
| HiVHAC | 150 | 3.6 | 2800 | Xe |
| VASIMIR VX-200 | 5000 | 200 | 5000 | Ar |
| Fetta-Cannae Drive | 0.01 | 0.0105 | Infinite | none |
| FIG. 4 Embodiment | 193* | 0.50* | Infinite | none |
| FIG. 6 Embodiment | 432* | 1.00* | Infinite | none |

*Design calculation

It is to be understood that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. An electromagnetic propulsion system comprising:
a structural disc assembly having a current conductor about its circumference;
a means for rotating the disc assembly at various speeds;
a means for sending a current through the conductor of the disc assembly;
one or more electromagnetic reaction coils;
a means for sending a current through the electromagnetic reaction coils;
a means for controlling the current amplitudes;
wherein a net unidirectional force is created by the interaction of the angular acceleration magnetic field component produced by the current in the rotating disc assembly with the currents in the reaction coils.

2. An electromagnetic thrusting system according to claim 1, wherein the conductor on the rotating disc assembly is comprised of one or more conductive coils.

3. An electromagnetic thrusting system according to claim 1, wherein the rotating disc assembly may have a core of high relative magnetic permeability material.

4. An electromagnetic thrusting system according to claim 1, wherein the reaction coils may be either static or counter-rotating with respect to the disc assembly.

5. An electromagnetic thrusting system according to claim 1, wherein some of the reaction coils are comprised of continuous toroids arranged circumferentially about he disc assembly.

6. An electromagnetic thrusting system according to claim 1, wherein some of the reaction coils are comprised of several discontinuous toroidal segments arranged circumferentially about the disc assembly.

7. An electromagnetic thrusting system according to claim 1, wherein the reaction coils may have cores of high relative magnetic permeability material.

8. An electromagnetic thrusting system according to claim 1, wherein two or more disc assemblies may be arranged along an axis of symmetry and rotated by a single common means.

9. An electromagnetic thrusting system according to claim 1, wherein current in the disc assembly coils may be constant, pulsed, or continuously time-varying.

10. An electromagnetic thrusting system according to claim 1, wherein current in the reaction coils may be constant, pulsed, or continuously time-varying.

11. An electromagnetic thrusting system according to claim 1, wherein the cores of the disc assembly and the reaction coils are engineered so as to minimize or eliminate potential eddy currents produced by incident magnetic fields.

12. An electromagnetic thrusting system according to claim 1, wherein the rotation rate of the disc assembly may be varied.

13. An electromagnetic thrusting system according to claim 1, wherein the counter-rotation rate of the reaction coils may be varied.

14. An electromagnetic thrusting system according to claim 1, wherein a net unidirectional force on the system may be generated substantially parallel to the axis of rotation of the disc assembly.

15. An electromagnetic thrusting system according to claim 1, wherein a net unidirectional force on the system may be generated substantially perpendicular to the axis of rotation of the disc assembly.

16. An electromagnetic thrusting system according to claim 1, wherein a net unidirectional force on the system may be generated substantially with components both perpendicular and parallel to the axis of rotation of the disc assembly.

17. An electromagnetic thrusting system according to claim 1, wherein a net torque on the system may be generated substantially perpendicular to the axis of rotation of the disc assembly.

18. An electromagnetic thrusting system according to claim 1, wherein a net torque on the system may be generated substantially parallel to the axis of rotation of the disc assembly.

19. An electromagnetic thrusting system according to claim 1, wherein any combination of net torque and forces on the system according to claims 14 through 18 may be generated.
